(19) United States
(12) Patent Application Publication
(10) Pub. No.: US 2012/0084101 A1
(43) Pub. Date: Apr. 5, 2012

(54) SYSTEM AND METHOD FOR LONGITUDINAL DISEASE MANAGEMENT

(75) Inventor: Asim H. Qadri, Eden Prairie, MN (US)

(73) Assignee: PRM, LLC, Eden Prairie, MN (US)

(21) Appl. No.: 13/376,651

(22) PCT Filed: Jun. 10, 2010
(86) PCT No.: PCT/US2010/001668

§ 371 Date: Dec. 7, 2011

Related U.S. Application Data
(60) Provisional application No. 61/185,871, filed on Jun. 10, 2009.

(51) Int. Cl. G06Q 50/24

(52) U.S. Cl. 705/3

(57) ABSTRACT

A longitudinal medical outcome collection and reporting (LMOCR) system provides a system for collecting, storing and displaying medical information. In particular, the system includes a patient database for storing medical records and information pertaining to a plurality of patients. The LMOCR system further includes an application server that stores applications for communicating with the patient database, a remotely located patient device, and a remotely located provider device. The application server includes a patient module that displays on the patient device a patient portal that allows the patient to interact with the LMOCR system. The patient module provides a questionnaire to the patient portal to collect information from the patient and applies a first set of rules to collected patient information to selectively modify the questionnaire to collect relevant follow-up information from the patient. The application server further includes a provider module that displays on the provider device a provider portal that allows the provider to interact with the LMOCR system. The provider module applies a second set of rules to collected patient information to translate the collected patient information into a format relevant to the provider, wherein the provider is able to review, modify, and add to the collection of patient data stored in the patient database.

### BACKGROUND

The present invention is related to disease management, and in particular to a system for automating the collection and communication of data with respect to disease management.

Unlike other types of medical care, which are often initiated in response to a particular event (i.e., a heart attack), disease management is process driven. As such, disease management typically requires a provider to document, validate, and integrate data provided from disparate sources over an extended period of time (sometimes over many years). Efficient management of the disease requires the collected data to be accessible in a meaningful way. In addition, insurers require some of the collected data to be included in billing reports, and credentialing bodies require access to data for purposes of monitoring the efficacy of the treatment/management.

Collecting the data into a database typically requires the medical provider to manually enter information based on notes or dictations provided by the doctor. This process is both time-consuming and error prone. Prior solutions have attempted to mine a doctor's notes and/or dictations for data collection purposes, but inconsistencies between providers makes this solution difficult to implement.

It would therefore be beneficial if a system could be integrated to reduce the inefficiencies of longitudinal disease management.

### SUMMARY

A longitudinal medical outcome collection and reporting (LMOCR) system provides a system for collecting, storing and displaying medical information. The LMOCR system includes a patient database for storing medical records and information pertaining to a plurality of patients. The LMOCR system further includes an application server that stores applications for communicating with the patient database, a remotely located patient device, and a remotely located provider device. The application server includes a patient module that displays on the patient device a patient portal that allows the patient to interact with the LMOCR system. The patient module provides a questionnaire to the patient portal to collect information from the patient and applies a first set of rules to collected patient information to selectively modify the questionnaire to collect relevant follow-up information from the patient. the application server further includes a provider module that displays on the provider device a provider portal that allows the provider to interact with the LMOCR system. The provider module applies a second set of rules to collected patient information to translate the collected patient information into a format relevant to the provider, wherein the provider is able to review, modify, and add to the collection of patient data stored in the patient database.

### BRIEF DESCRIPTION OF THE DRAWINGS

FIG. 1 is a block diagram illustrating collection of data by a longitudinal medical outcome collection and reporting (LMOCR) system according to an embodiment of the present invention.

FIG. 2 is a block diagram illustrating the longitudinal collection of data and generation of reports related to bariatric surgery according to an embodiment of the present invention.

FIGS. 3A-3B are block diagrams illustrating a hardware configuration used to implement the LMOCR system according to an embodiment of the present invention.

FIG. 4 is a flowchart illustrating process steps employed by the LMOCR system according to an embodiment of the present invention.

FIGS. 5A-5B are screenshots illustrating the dynamic patient questionnaire displayed on a patient portal according to an embodiment of the present invention.

FIGS. 6A-6B are screenshots illustrating the transformation of information provided via the patient portal to information displayed to a provider via the provider portal.

FIGS. 7A-7H are screenshots illustrating the collection of data from a patient portal according to an embodiment of the present invention.

FIGS. 8A-8J are screenshots illustrating collection/verification and reporting of collected data from a provider portal according to an embodiment of the present invention.

FIGS. 9A-9B are screenshots of automated letters generated by the LMOCR system according to an embodiment of the present invention.

FIGS. 10A-10B are screenshots of reports generated by the LMOCR system according to an embodiment of the present invention.

### DETAILED DESCRIPTION

The present invention is directed to a longitudinal medical outcome collection and reporting (LMOCR) system that provides an alternative to prior art methods of populating, implementing, and making use of electronic medical records. In particular, the present invention gives limited ownership/access of medical records to patients, allowing patients to take responsibility of populating their own medical records. This allows the database to be populated in a manner more efficient to care providers. Once populated, the collected data is translated to a form convenient and useful for the provider to allow the provider to review, modify, or otherwise edit the collected data. Based on the collected information, the system provides for automated note and task list generation.

This type of system is particularly well-suited to the documentation, validation, and integration of data required for long-term disease management. Process-driven disease management (as opposed to event driven episodes, e.g., heart attacks) typically requires the collection of data from disparate sources over a long period of time. Patient participation in managing the database improves efficiency from the perspective of the care provider and provides the patient with an ownership role in managing the disease. As a result of the extended time period associated with disease management, the organization of data related to the disease management becomes longitudinal in nature. One application of the present invention is in bariatric surgery, which requires collection of information from patients and providers, organization of the collected data for validation (i.e., approval of the planned surgery) by a credentialing body, and integration of the data for long-term monitoring following the surgery. The following disclosure describes the present invention in view of this particular application, although the present invention may be employed in other applications with respect to long-term disease management.

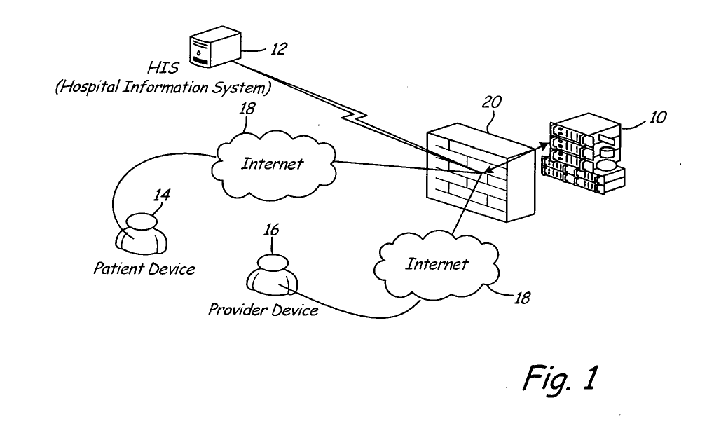

FIG. 1 is a block diagram illustrating collection of data by longitudinal medical outcome collection and reporting system 10 (hereinafter, LMOCR 10) according to an embodiment of the present invention. As shown in FIG. 1, LMOCR 10 is connected to communicate with hospital information system 12 (hereinafter, HIS 12), and communicates with remotely located patient device 14 and provider device 16, which allow patients and providers to access LMOCR 10 via internet 18. Firewall 20 provides security for communications between LMOCR 10 and connected devices.

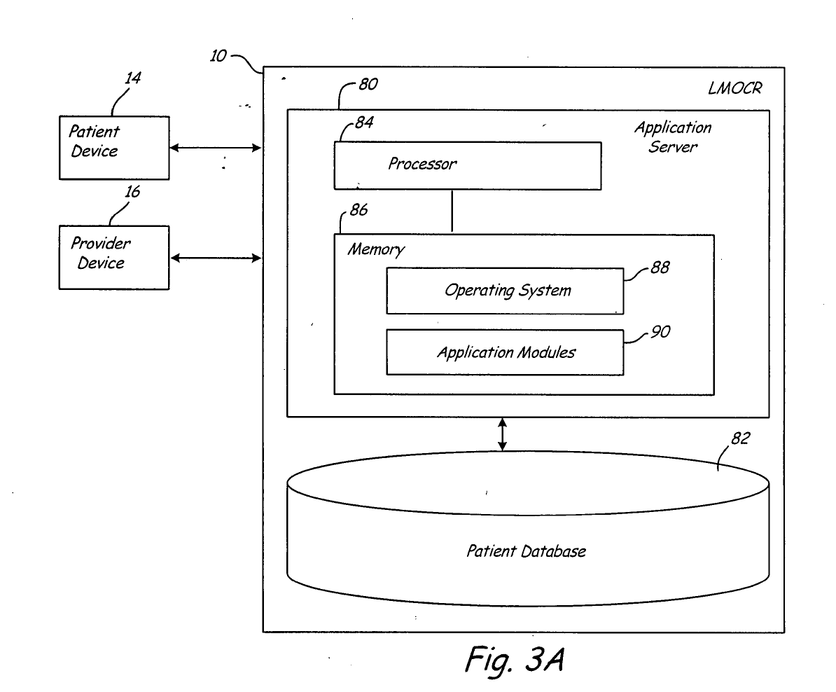

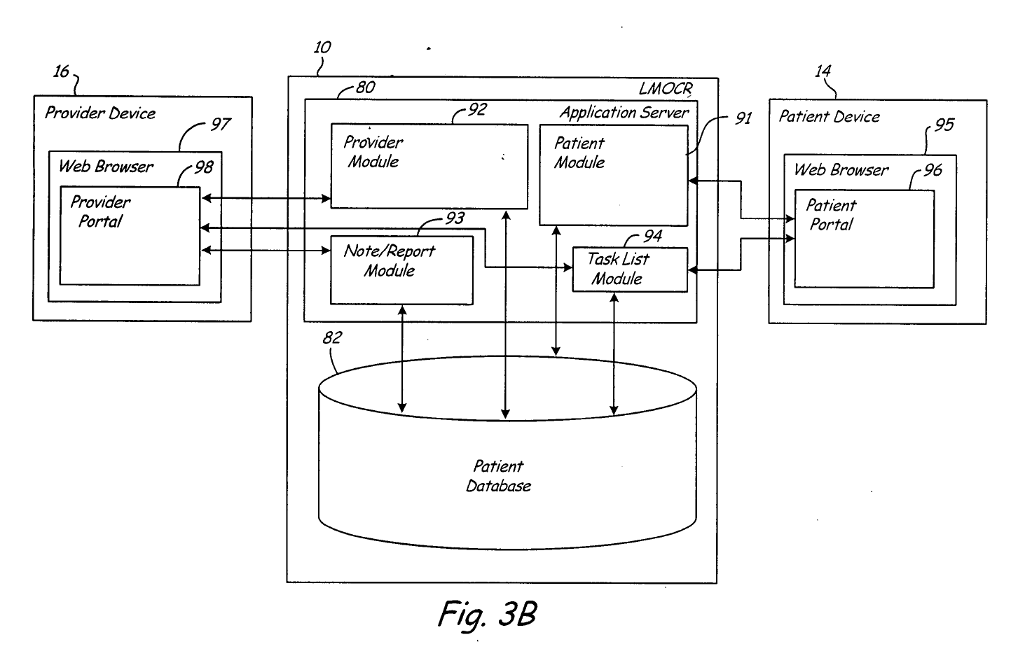

Patient device 14 employs an internet-based (i.e., web-based) interface hosted by LMOCR 10 that allows patients to schedule/view appointments, provide information via online questionnaires, communicate questions/concerns to the provider, and view tasks that must be completed by the patient. The hosted application (described in more detail with respect to FIG. 3B) is stored locally by LMOCR 10, but can be accessed by patients with proper login credential, and allows the patient to interact with LMOCR 10.

Provider device 16 similarly employs an internet-based (i.e., web-based) interface hosted by LMOCR 10 that allows a provider (e.g. nurse, physician, assistant, etc.) to schedule/view appointments, generate provider notes, generate/view patient tasks, and generate/view reports. The hosted application (described in more detail with respect to FIG. 3B) Provider portal 16 is stored locally by LMOCR 10, but can be accessed by providers with proper login credentials, and allows the provider to interact with LMOCR 10.

Hospital information system (HIS) 12 is a database that stores patient records. The term hospital information system is used to generically describe information systems employed in the medical field, including evaluation/management (EM) systems, patient scheduling systems, patient billing systems, and patient lab systems. In the embodiment shown in FIG. 1, LMOCR 10 is integrated with HIS 12 such that both systems share information. A patient entering the bariatric surgery process may have medical records stored by HIS 12 that can be imported to LMOCR 10. For example, patient demographics, allergies, medications, vitals, and lab results may have already been collected by HIS 12. This information can be provided to LMOCR 10 to populate data fields without requiring the provider to re-enter the information. In other embodiments, LMOCR 10 may be a standalone system that does not share information with HIS 12. In a standalone system, LMOCR 10 would be responsible for collecting the information otherwise provided by HIS 12 and generating the patient scheduling/billing reports independent of HIS 12.

LMOCR 10 is comprised of a combination of hardware and software components. Software components are stored on computer readable medium, which when executed operates to implement the interfaces and modules used to provide interaction between patients, providers, and LMOCR 10. Data collected via these interfaces, as well as data received from other systems, such as HIS 12, is stored by LMOCR 10 in a database. In particular, database relationships link the data such that once collected, the data is automatically inserted into various interfaces and templates without requiring the patient or provider to repetitiously re-enter the same data. The operation of LMOCR 10 is described with respect to these interfaces and the linking of data between various interfaces. In addition, LMOCR 10 includes modules for organizing the collected data into automated letters/reports that can be used for billing purposes, referral letters, and notes.

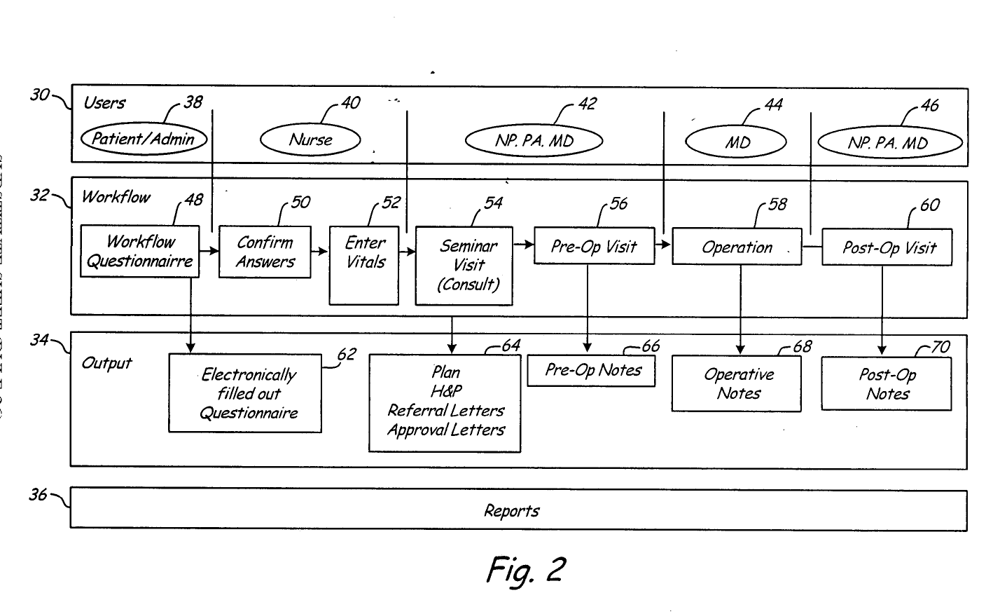

FIG. 2 is a block diagram illustrating the longitudinal collection of data and generation of reports related to bariatric surgery according to an embodiment of the present invention. The process is segmented to illustrate at each step the user responsible for entering/collecting data (block 30), the steps or workflow making up the process (block 32), the output generated as a result of the process (block 34), and reports generated by the process (block 36).

In the embodiment shown in FIG. 2, at step 48 a patient and/or administrator provides information in response to an electronic patient questionnaire (displayed via patient device 14 shown in FIG. 1). Data collected via the electronic patient questionnaire is provided as an output at step 62. At various stages of the process additional electronic questionnaires may be made available to patients to complete. For example, a post-operative questionnaire may be required that collects additional information related specifically to the patient's health after surgery. As discussed in more detail below, information collected from patients using the electronic questionnaire is used to automatically populate data fields otherwise required to be completed by the provider. This reduces the provider time required to enter information. Populated data fields can be reviewed by a provider and modified as desired, thereby alleviating repetitious data entry.

In another embodiment, patients that do not have access Internet access, may call/visit an administrator to have the information entered manually. The information collected by the administrator is entered into LMOCR 10 and used in subsequent encounters in the same way data collected via the electronic questionnaire is employed.

At step 50, a nurse/assistant reviews answers provided via the electronic patient questionnaire at a patient visit (i.e., an encounter). If changes need to be made to the electronic patient questionnaire, the nurse/assistant may access the electronic questionnaire via provider device 16 (shown in FIG. 1) and make any necessary changes. In addition, the nurse/assistant takes vital information (e.g., heart rate, blood pressure, etc.) and records the information via provider device 16 to store the information to LMOCR 10.

At step 54, the patient meets with a nurse practitioner (NP), physician assistant (PA), and/or medical doctor (MD) (i.e., physician) to discuss available procedures. During the seminar visit, the physician may annotate or add to the information collected about the patient via provider portal 16 (as shown in FIG. 1). Meetings between the patient and provider are referred to generally as “encounters.” At each encounter, the provider employs the provider interface 16 to review/modify data previously collected about the patient. Based on the collected data, at step 64 LMOCR 10 employs automation rules to generate an individual health and physical and/or process plan assessments for the patient. Health and physical assessments relate to the overall health of the patient and suitability for surgery. Generation of health and physical assessments may be automated based in part on the questionnaire provided by the patient, and additional information input by the nurse/physician during an encounter. Factors may include smoking history, weight, age, previous health conditions, as well as other factors relevant to the overall health of the patient. The process plan may include the type of surgery recommended by the physician, tasks that must be completed prior to the surgery (i.e., weight loss requirements, scheduled visits with a dietician, etc.), and other notes corresponding to the selected course of action.

Automated outputs such as health and physical/process plan assessments may be modified by the physician based on the physician's experience. Reducing the amount of data collection performed by the physician through the use of electronic questionnaires, and automating plan assessments based on the collected data reduces the overall physician time required. In particular, LMOCR 10 reduces repetitious and error-prone data entry otherwise required of a provider. LMOCR 10 allows a physician to review the automatically generated plan and/or assessment and make modifications as required.

In addition, at step 64 LMOCR 10 automates generation of referral letters to the referring doctor and approval letters required by insurance companies based on the collected information. The automated referral letters and approval letters can be modified by the physician. Once again, the benefit of the automated referral letters and approval letters generated by LMOCR 10 is physician time is minimized in dictating or otherwise generating the letters.

In addition, data collected during the seminar visit (i.e., encounter) is stored and employed as a baseline for subsequent visits. In this way, repetitive information does not have to be re-visited and re-entered at subsequent encounters. Rather, the patient/physician can review the information and make modifications only to those fields that have changed. For instance, if medications have remained unchanged since the last visit, the patient/physician are not required to list or discuss all medications currently being taken by the patient. In some instances, governing or credentialing bodies require review of patient data either to assess the benefits or efficacy or various treatments or to sign-off on recommended treatments. LMOCR 10 allows the required information to be uploaded or otherwise communicated to the credentialing board.

At step 56, the patient meets with the nurse NP/PA/MD for a pre-operation visit (i.e., another encounter). In addition to the seminar visit, the patient may have several other encounters with a physician prior to surgery. At each of these encounters, the process remains approximately the same, with the patient/physician reviewing collected patient information, making changes or modifications to the file, re-assessing the health and physical information/plan, and generating notes and/or letters.

As discussed above, patient information collected at a previous encounter can be reviewed by the patient/physician via provider interface 16 and modifications can be made as necessary. This prevents the physician or physician's assistant from having to re-enter largely repetitive information. In addition to saving time, this also prevents errors and mistakes that arise during repetitious data entry.

In response to information collected during the pre-operation visit, LMOCR 10 automatically generates pre-operation notes at step 66. Once again, the physician may access the generated pre-operation notes through provider interface 16 and make changes or modifications as desired. Pre-op notes may also be communicated to governing/credentialing bodies as required. Pre-op notes are stored by LMOCR 10.

At step 58, the patient undergoes surgery. Data is once again collected/reviewed at this encounter via provider device 16 as described above. Subsequent to the surgery, at step 68 LMOCR 10 generates operative notes for the physician to review/modify as desired. For example, operative notes may include the type of bariatric device employed in the surgery, the fit of the device, any complications experienced during the surgery, or notes for subsequent follow-ups. Operation notes may also be communicated to governing/credentialing bodies as required. This information is stored by LMOCR 10.

At step 60, the patient returns for post-operative visits. At this encounter, the patient/physician review collected patient information, making changes or modifications to the collected information, and collect new information. For example, with respect to bariatric surgery, the amount of weight loss between each encounter is closely monitored to determine whether the rate of weight loss is healthy. Post-operation notes are automatically generated for the physician to review/modify as desired and may be provided to governing/credentialing bodies as required. Post-operation notes are also stored by LMOCR 10.

In addition to outputs 34 discussed above, reports 36 may be generated at any time during the process. Reports may be patient specific (e.g., weight loss of a particular patient over time) or general. For example, a report may show how many patients are currently in the pre-operation process, or the average weight loss for each patient based on different types of surgery. These reports are particularly beneficial in monitoring the long-term benefits of various processes for large numbers of patients. With this information, physicians are able to better determine which processes are most beneficial for patients.

FIG. 3A is a block diagram illustrating a hardware environment used to implement LMOCR system 10 according to an embodiment of the present invention. In the embodiment shown in FIG. 3A, LMOCR 10 includes application server 80 and patient database 82. Application server 80 includes processor 84 and memory 86, which stores operating system 88 and application modules 90. Application server 80 operates under the control of operating system 88, which is booted into memory 86 of application server 80 for execution by processor 84. In turn, operating system 88 controls the execution of application modules 90. Application modules 90 allow application server 80 to interact with patent device 14, provider device 16, and patient database 82. Those skilled in the art will also recognize that the environment illustrated in FIG. 3A is not intended to limit the present invention. Indeed, those skilled in the art will recognize that other alternative hardware environments may be used without departing from the scope of the present invention.

FIG. 3B is a block diagram illustrating communication between various application modules implemented by application server 80 and patient device 14 and provider device 16. In the embodiment shown in FIG. 3B, application server 80 provides application modules that include patient module 91, provider module 92, note/report module 93 and task list module 94. Patient module 91 interacts with patient database 82 and client device 14, while provider module 92 and note module 93 each interact with patient database 82 and provider device 16. Task list module 94 interacts with patient device 14, provider device 16, and patient database 82 to generate and maintain a list of tasks to be completed by the patient as part of the disease management process.

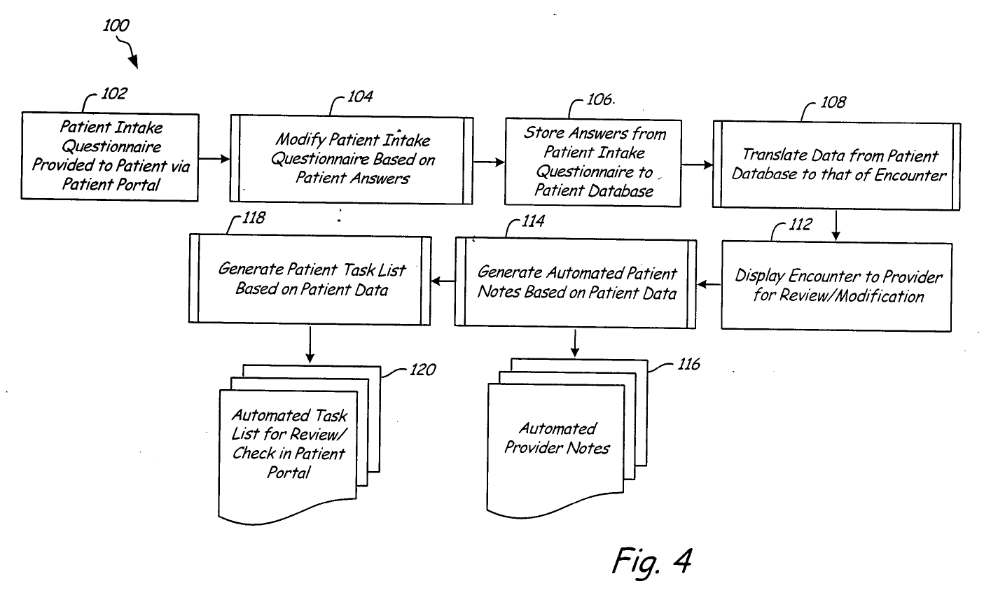

In the embodiment shown in FIG. 3B, client device 14 includes web-browser 95. Similar to the combination of hardware and software employed by application server 80, client device 14 would include a combination of hardware and software for implementing web browser 95 (e.g., Internet Explorer, Google Chrome, Firefox, etc.) that allows client device 14 to communicate over Internet 18 with patient module 91, which hosts patient portal 96 displayed within web-browser 95. Through patient portal 96, a patient is allowed to interact with LMOCR 10. As described in additional detail with respect to FIG. 4, patient module 91 hosts the electronic patient questionnaire used to collect data from patients via patient portal 96. In addition, patient module 91 dynamically modifies the questionnaire in response to information collected from the patient to ensure all relevant patient information is collected. Information collected from the patient via the electronic questionnaire is provided by patient module 91 to patient database 82 for storage and subsequent access by other modules (such as provider module 92 and note module 93).

Likewise, provider device 16 includes a combination of hardware and software, which when executed on provider device 16 provides an instance of Web browser 94 that allows provider device 16 to communicate via Internet 18 with provider module 92. Provider module 92 hosts a provider portal 98 that is displayed on provider device 16 to allow the provider to interact with LMOCR 10. In particular, provider module 96 translates collected patient information in a meaningful way for provider review, and allows the provider to modify the collected information as necessary.

Note module 93 interacts with provider portal 98 and patient database 82 to automate the generation of provider notes. In particular, a provider (via provider portal 98) interacts with note module 93 to dictate the type of note to be created, and note module 93 interacts with patient database 82 to automate the production of the desired note. This obviates the need for the provider to dictate or type notes.

Task list module 94 interacts with provider portal 98 and patient database 82 to automate the generation of task lists (i.e., a list of activities to be completed by the patient). Task list module 94 interacts with patient portal 96 to display the generated task list and to receive input regarding tasks completed by the patient. Input may include documents uploaded by the patient via patient portal 96, electronic mail messages, or other types of electronic data that can be communicated to task list module 94. In response to one or more of these inputs, task list module 94 stores the input to patient database 82.

FIG. 4 is a flowchart that illustrating operation of LMOCR 10 according to an embodiment of the present invention. For purposes of explaining the process, reference is made to the hardware configuration described with respect to FIG. 3B, although it is understood that other hardware configurations may be employed to carry out the described steps.

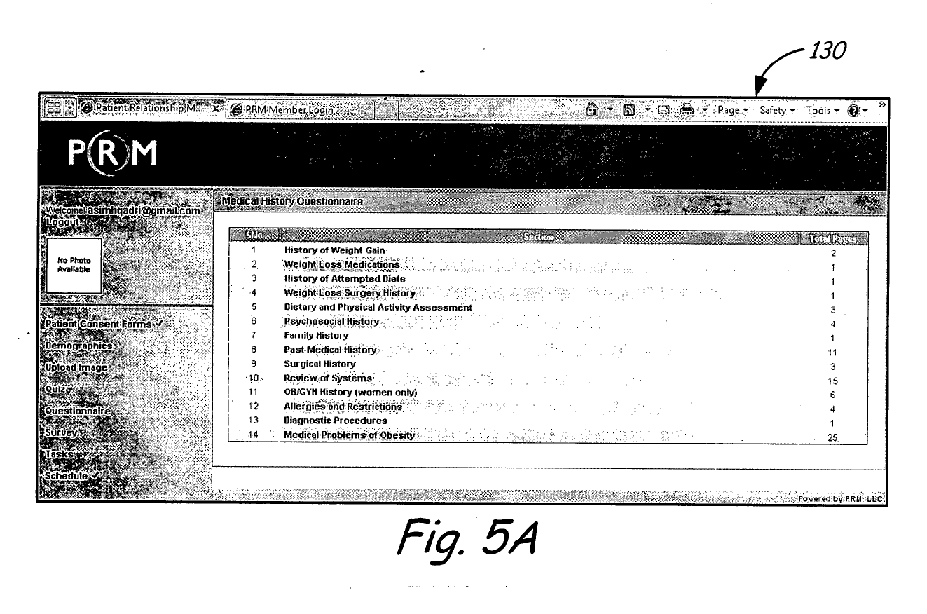

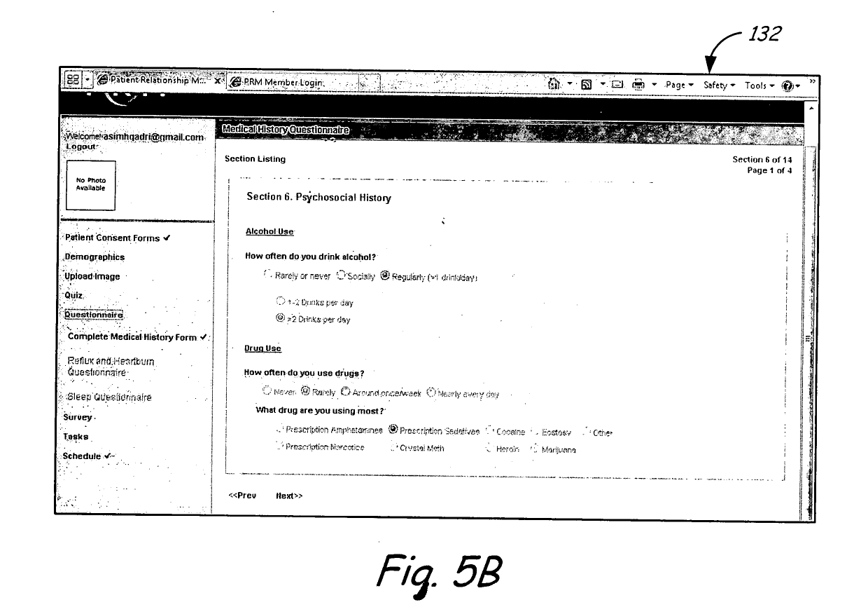

At step 102, a patient intake questionnaire generated by patient module 91 is provided to patient portal 96 for review and feedback from the patient, exemplary portions of which are illustrated in FIGS. 5A and 5B, described below. The patient intake questionnaire is displayed to the user via patient portal 96. The displayed patient intake questionnaire prompts the user for information regarding the patient's medical history.

At step 104, the patient intake questionnaire is modified in response to answers provided by the patient. In one embodiment, patient module 91 includes a first set of rules (i.e., questionnaire rules) that are applied to answers provided by the patient. In this way, based on certain responses from the patient, the questionnaire is modified to ask relevant follow-up questions without interaction from a provider (i.e., nurse, doctor, etc.). For example, if a patient answers in the negative a question regarding whether or not the patient drinks alcohol, no follow-up questions are presented to the patient. However, if the patient answers in the affirmative, an automated follow-up question is presented to the user that asks more particular questions regarding the patient's consumption of alcohol.

At step 106, information provided by the user in response to the patient intake questionnaire is stored in patient database 82. Information stored in patient database 82 may also include date-stamping, which is particularly relevant in managing longitudinal diseases. In addition, information regarding who (i.e., patient, provider, etc.) provided the information may be included in patient database 82.

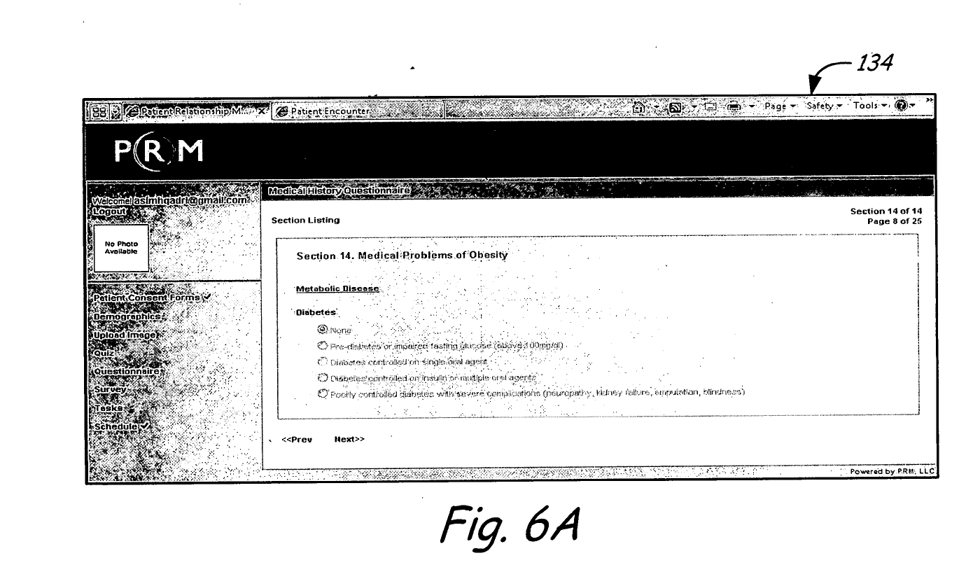

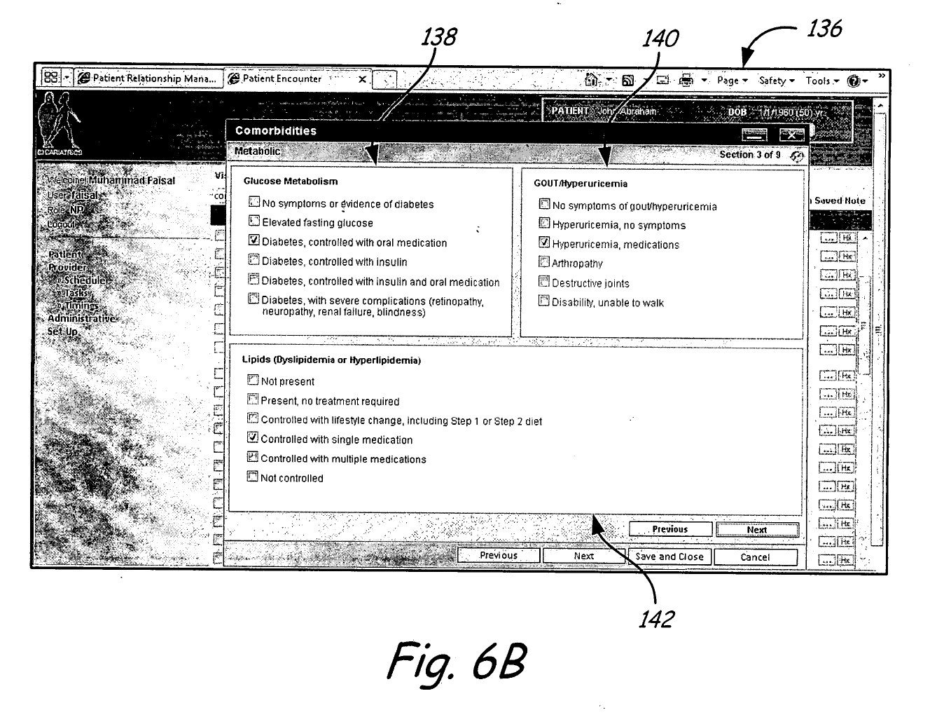

At step 108, the data stored in patient database 82 is translated from patient database 82 to a patient encounter for review by a provider. In particular, provider module 92 retrieves patient information from patient database 82 and applies a second set of rules (i.e., provider translation rules) to the retrieved data to generate translated data. Translation of the patient intake data to patient encounter data presents the patient intake data in a form that is more useful to a provider. For example, a patient provided weight and height may be translated into a body-mass index and displayed to the doctor in combination with the patient weight/height information. Data translation may further include automatically generating prompts or queries generated in response to the patient provided information. In the example provided in FIGS. 6A-6B, in response to a patient indicating on the patient questionnaire (FIG. 6A) that the patient has previously been diagnosed with some form of diabetes, the provider is prompted to address comorbidities associated with the primary diagnosis. In the example provided in FIG. 6B, comorbidities include GOUT/Hyperuricernia and Lipids. In this way, a provider is automatically prompted based on information collected from the patient to address those questions that cannot be addressed by the patient.

At step 112, the patient encounter is displayed to the provider via provider portal 98 for review/modification. A benefit of translating/displaying the collected information to the provider in this way, is it prevents the provider from having to walk-through or review the entire patient questionnaire and answers provided in response. Rather, the information is presented in a way that is easily reviewed by the provider. In addition, the translation of data from patient database 82 to a patient encounter results in a variety of automated prompts and questions for the provider to review and answer, allowing the provider to modify/add information with respect to the patient encounter without having to generate notes or dictation that require subsequent manual entering into the patient database. In this way, efficiency of the provider is improved because of the transformation of data into a form that allows doctors to review and modify without having to create separate notes. In addition, modification of patient data does not require the participation of both a doctor in making notes and a nurse or assistant in copying the notes/dictation into a medical records system, thereby providing the provider with greater efficiency.

At step 114, automated provider notes/letters are generated by note creation module 93 based on the collected data, as provided by the patient and reviewed/modified by the provider. As illustrated by the plurality of notes 116, a provider may generate a plurality of automated notes/letters. For example, a doctor will typically send notes/letters to referring physicians apprising them of the diagnosis and planned treatment, as well as to other medical personnel. However, the generation of a plurality of notes is a time-consuming process.

In the embodiment shown in FIG. 3B, note creation module 93 interacts with provider portal 86 and patient database 82 to automate the generation of provider notes. To generate a note, a provider interacts with note module 93 via provider portal 98 to indicate the type of note to be created. Based on the type of note to be created, note module 93 applies a third set of rules (i.e., note-creation rules) to retrieve patient-specific data stored in patient database 82 and to place the retrieved data within the note/letter.

At step 118, automated task lists for the patient are generated based on the patient data. In the embodiment shown in FIG. 3B, task list module 94 interacts with provider portal 98, patient database 82, and patient portal 96 to generate tasks lists for the patient to review and complete. Based on information provided by the patient and reviewed by the provider during the patient encounter, task list module applies a fourth set of rules (i.e., task list rules) that generate an automated set of task lists for the patient to complete. In the example of bariatric surgery, the task list may include visits with a psychologist to verify patient readiness, weight loss requirements prior to surgery, etc. The provider reviews the automated set of task lists via provider portal 98 and modifies it as necessary. The reviewed task list is stored in patient database 82, where it can be accessed by the patient via patient portal 96 and task list module 94. As the patient completes tasks, the patient may be allowed to indicate or upload documents verifying that the task has been completed.

The generated task list(s) are illustrated by the plurality of documents 120, which may be reviewed and edited by the patient via patient portal 96. Edits to the task list may be predicated on certain documents, messages, etc. being uploaded by the patient via patient portal 96 to task list module 94. Updates to the task list as well as documents uploaded by the patient are stored by task list module 94 to patient database 82.

A benefit of the process described with respect to FIG. 4 is the patient is allowed via patient module 91 to populate much of the data in patient database 82. This baseline of data provided by the patient is utilized by patient module 91 to ask relevant follow-up questions (e.g., application of questionnaire rules), translate collected data for meaningful review by the provider 9 e.g., application of translation rules), automate the generation of physician notes (e.g., application of note-creation rules), and automate the generation of patient task lists (e.g., application of task list rules).

FIGS. 5A-5B are screenshots (130 and 132, respectively) of the questionnaire displayed to the patient via patient portal 96 (as shown in FIG. 3B). In particular, FIG. 5A illustrates an overview of the medical history questionnaire presented to the user, with a plurality of topics that may be reviewed by the user at their discretion. In this example, the patient answers questions related, in particular, to bariatric (i.e., weight loss) surgery. The example provided in FIG. 5A consists of 14 sections, labeled:

1. History of Weight Gain

2. Weight Loss Medications

3. History of Attempted Diets

4. Weight Loss Surgery History

5. Dietary and Physical Activity Assessment

6. Psychosocial History

7. Family History

8. Past Medical History

9. Surgical History

10. Review of Systems

11. OB/GYN History

12. Allergies and Restrictions

13. Diagnostic Procedures and

14. Medical Problems of Obesity.

Typically this questionnaire is a paper questionnaire that requires subsequent review and entry of the patient's answers into the hospitals electronic data storage system. In addition, a patient is typically required to review/answer all questions in the questionnaire, even those that may not be relevant to the patient. In contrast, the questionnaire rules applied by patient module 91 dynamically modify the questions presented by the questionnaire to the patient based on answers provided by the patient.

FIG. 5B illustrates a simple example of the application of rules to dynamically modify the questions presented to the user. In this section of the questionnaire, the patient is asked about previous/current drug and alcohol use. The patient is asked first how often they drink alcohol, either rarely or never, socially or regularly. If the patient responds that they drink regularly, then based on a set of questionnaire rules applied by patient module 91 follow-up questions are presented to the user regarding how many drinks they consume each day. This follow-up question is only displayed to the patient based on the patient's indication that he drinks alcohol regularly. Similarly, if a patient responds that he/she uses drugs, either rarely, around once/week, or nearly every day, then based on a set of questionnaire rules applied by patient module 91 follow-up questions are presented to the user regarding what types of drugs the patient uses. In this way, the patient is only required to review/answer relevant questions. In addition, the application of questionnaire rules to modify the questions presented to the user is invisible to the user.

FIGS. 6A and 6B are screenshots (134 and 136, respectively) illustrating an example of the data transformation applied by provider module 92 to information provided by the patient via the patient questionnaire, and the resulting information displayed to the provider.

FIG. 6A illustrates a portion of the questionnaire displayed to the user via patient portal 14 regarding the presence of previously diagnosed metabolic diseases, in particular diabetes. In this example, the patient indicates a previous diagnosis of diabetes, and that the condition is controller with a single oral agent. Rather than simple display this information in the same form to the provider, provider module 92 applies a set of translation rules to the received patient data to display the information in way that is meaningful to a provider. Thus, the information collected from a patient, which is displayed in a manner that is accessible and understandable to a patient, is translated into a form that is meaningful to a provider.

FIG. 6B illustrates a portion of the display provided to the provider via provider portal 56 illustrating an embodiment in which transformation of data includes prompting the provider with follow-up issues associated with potential comorbidities. In this way, not only is information translated into language that is meaningful to the provider, but the provider is actually prompted with additional comorbidities which may be present based on information collected from the patient.

This example employs a patient's response to diabetes questions provided in the patient questionnaire. In response to the patient indicating a previous diagnosis of diabetes controlled by a single oral agent, a set of provider rules applied by provider module 92 translates the information in a way that is useful to the provider. In this particular example, the transformation not only indicates to the provider the presence of the diabetic condition, but queries the provider to determine whether the patient is affected by any comorbidities associated with the primary disease, in this case diabetes. Comorbidities may be those diseases that are related or caused by an underlying disease, such as diabetes, or may be diseases unrelated to the primary disease, but which may present potential problems if present in a patient having the primary disease. In the present example, provider module 92 translates information entered by the patient via patient module 92 (e.g., in the screenshot provided in FIG. 6A) causes comorbidities window 138 to be display to the provider via provider portal 98. The comorbidities window includes a first portion 140 titled “Glucose Metabolism” that communicates to the provider the patient's indication of diabetes, controller with oral medication. In addition, the provider is presented with a second portion 142 titled GOUT/Hyperuricernia and a third portion 144 titled Lipids (Dyslipidernia or Hyperlipidernia) that requires the provider to determine and indicate whether these particular comorbidities are present.

In this way, information provided by the patient is transformed into a display that is meaningful to the provider. In addition, the transformation of data includes automating follow-ups to be analyzed and addressed by the provider during a patient encounter. It should be noted, that the automated features will not address every issue to be reviewed/analyzed by the provider, but rather seek to address common follow-ups in order to improve provider efficiency.

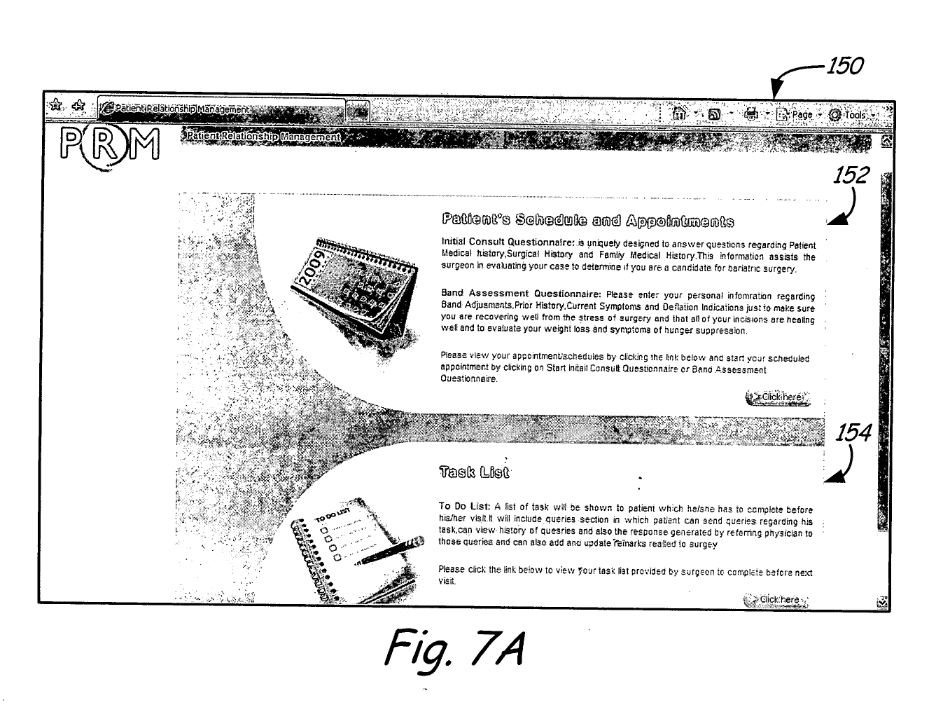

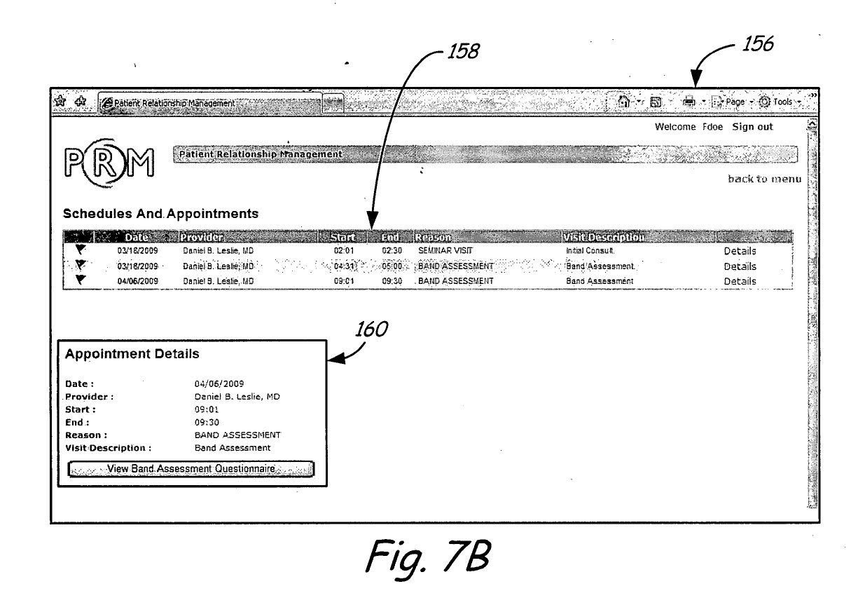

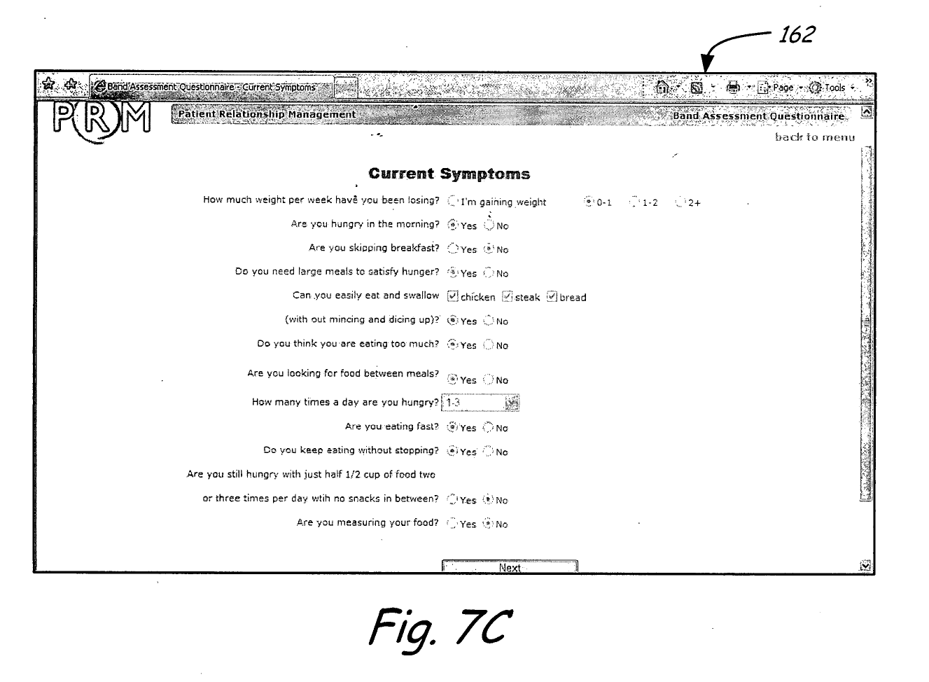

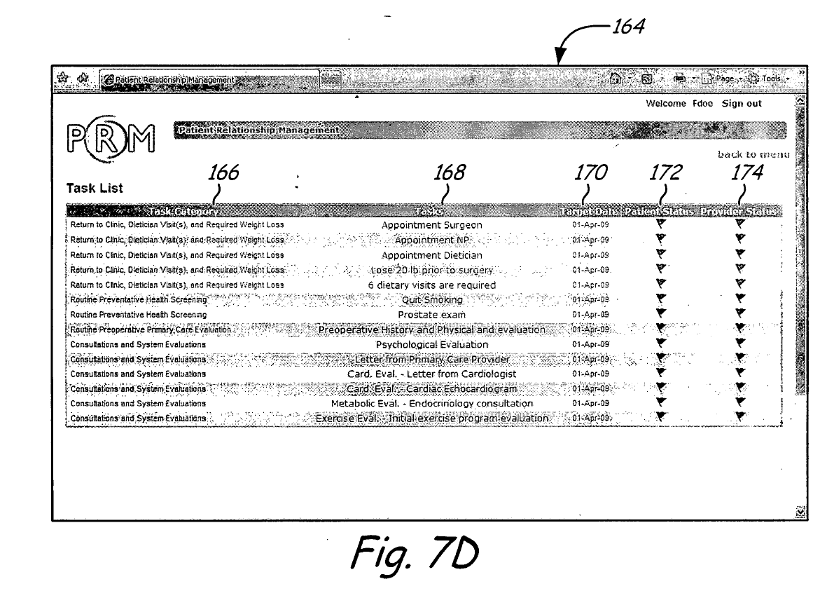

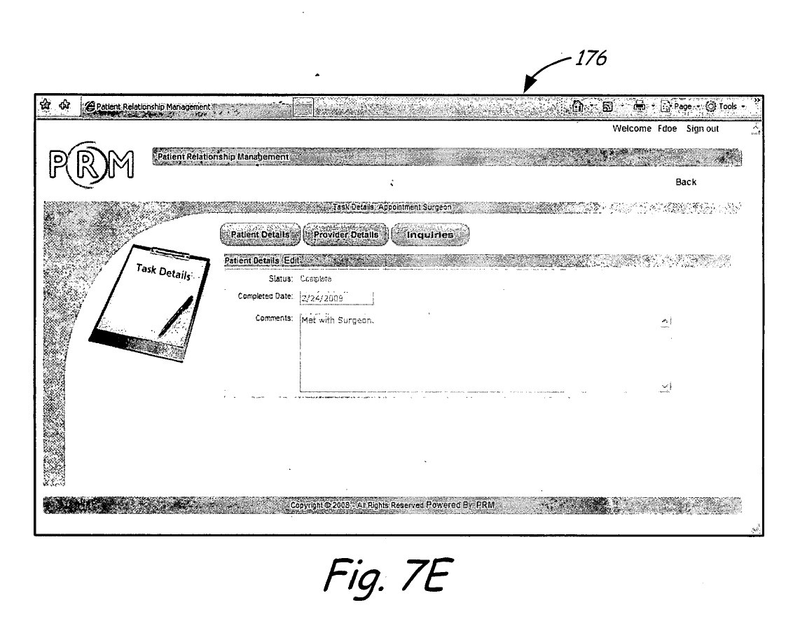

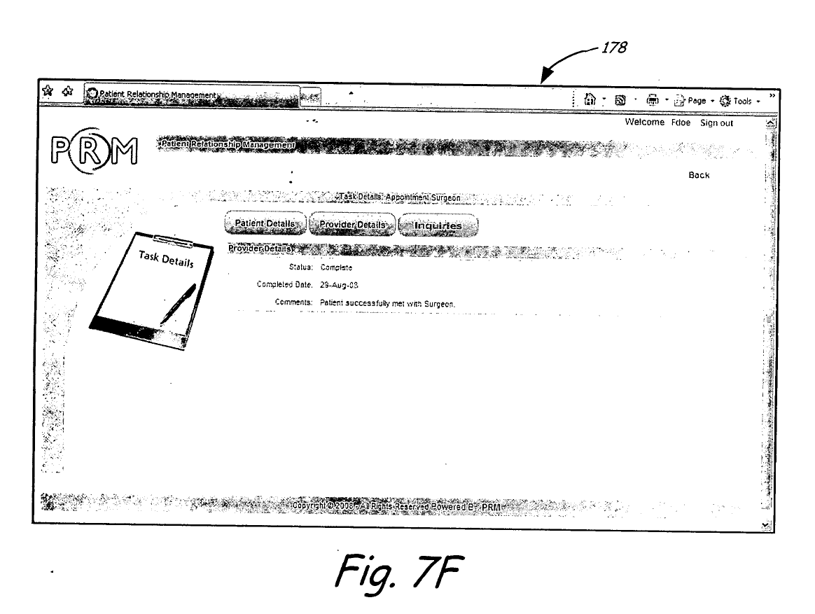

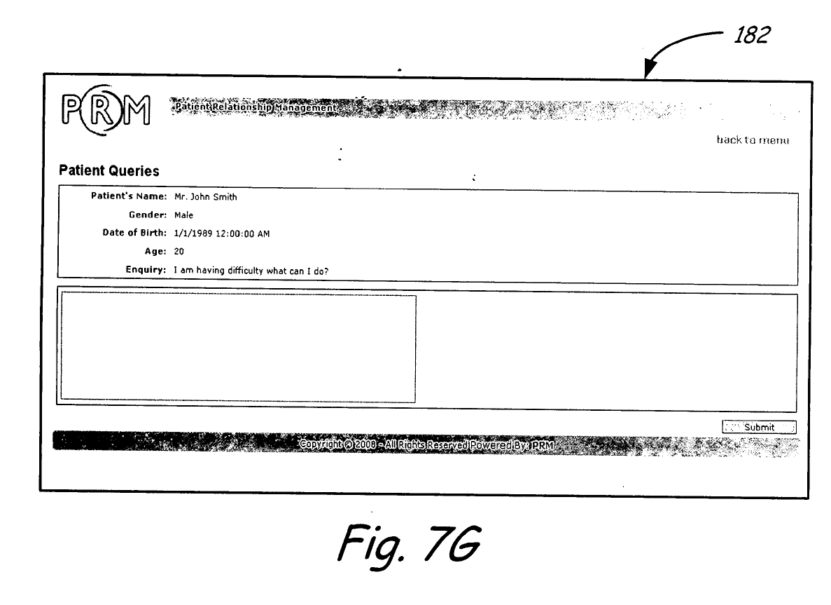

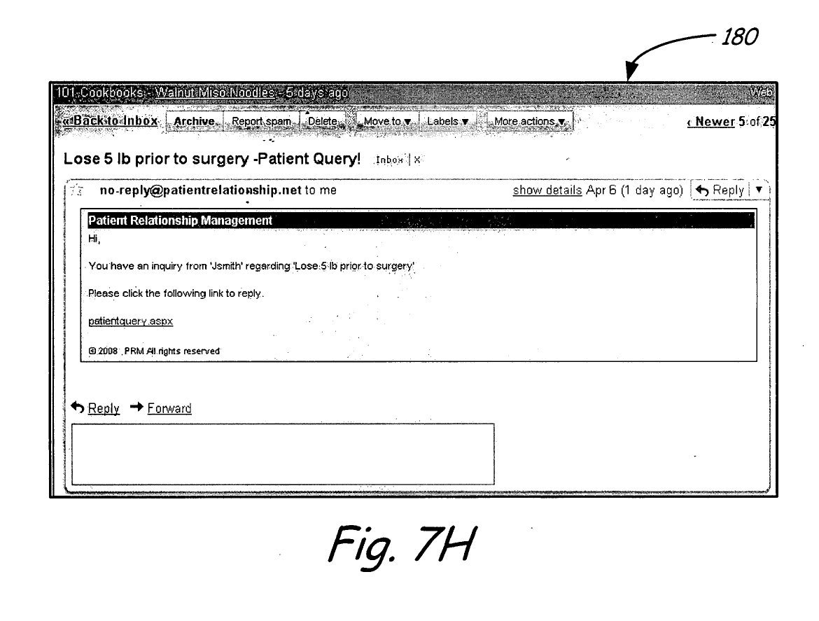

FIGS. 7A-7H are screenshots of the interface provided by patient portal 92 (shown in FIG. 1) for scheduling, data collection, task list review, and communication with a provider.

FIG. 7A is a screenshot of home page interface 150 viewable by a patient upon logging into patient portal 96. Home page interface 150 provides a roadmap of information that can be retrieved, reviewed, or provided to patient portal 96 via patient module 91. For example, in the embodiment shown in FIG. 7A, home page interface 150 includes portion 152 titled “Patient's Schedule and Appointments” that provides the questionnaires (e.g., initial consult questionnaire, band assessment questionnaire) to be completed by the patient prior to scheduled appointments. Home page interface 150 also includes portion 154 titled “Task List” that describes the tasks to be reviewed by a patient, and completed prior to a scheduled visit. In the embodiment provided in FIG. 3B, patient module 91 interacts with patient database 82 and patient portal 96 to provide the patient with questionnaires, while task list module 94 interacts with patient database 82, provider portal 98, and patient portal 96 to provide task lists to the patient.

FIG. 7B is a screenshot of schedule/appointment interface 156 that is displayed to a user in response to activating/clicking on Patient's Schedule and Appointment button shown in FIG. 3A. This page allows a patient to see all scheduled appointments via scheduled appointment interface 158 and details regarding a particular appointment via appointment details interface 160. In the embodiment shown in FIG. 7B, scheduled appointment interface 158 displays the date of the scheduled appointment, the provider/physician, appointment time, reason for the appointment, description of the appointment, and a link that when activated displays additional information regarding the appointment. A flag on the left side is colored to indicate whether the scheduled appointment is pending, completed, or missed.

By activating the “details” link for a specific appointment, details associated with the selected appointment are shown in appointment details interface 160. In addition to details regarding the date, time, physician and reason for the appointment, a link is provided to the questionnaire specific to the selected appointment. In the example shown in FIG. 3B, the reason for the appointment is for a “Band Assessment”. Included within the details of the specific appointment is a link to “View Band Assessment Questionnaire” that allows a patient to view and provide answers to an electronic questionnaire prior to the patient's appointment. In this way, the patient is able to populate patient database 82 with information prior to an encounter with the provider.

FIG. 7C is a screenshot of questionnaire interface 162 that is displayed to a user in response to activating/clicking on the link to “View Band Assessment Questionnaire” shown in FIG. 7B. The questionnaire shown in FIG. 7C may be in addition to or in conjunction with the exemplary embodiment of the questionnaire provided in FIGS. 5A and 5B. Questionnaire interface 162 includes a series of questions to which the user responds. Questionnaire interface 162 may take advantage of a number of input methods, including yes/no boxes, drop down lists, etc. In addition, LMOCR 10 may generate a given questionnaire based on previously answered questions or information previously gathered with respect to a particular patient. A rudimentary example would be gender related questions. If the patient's demographic information indicates that the patient is a male, then the questionnaire generated by LMOCR 10 would not include questions regarding pregnancy.

Information collected by questionnaire interface 162 at the direction of patient module 91 is stored to patient database 82. During a scheduled appointment (i.e., patient encounter), the answers to the questions are reviewed with the provider to ensure accuracy. This information is utilized by LMOCR 10 to automate encounter notes, generation of plans, health and physical reports, referral letters, approval letters, and other reports as discussed with respect to FIGS. 2 and 4. By giving patients the ability to populate information stored in patient database 82, this burden is relieved for the providers, thereby improving the overall efficiency of the providers.

FIG. 7D is a screenshot of task list interface 164 that allows a patient to view/complete various tasks automatically generated by task list module 94 (as shown in FIG. 3B) and reviewed by the provider. As discussed above, the task list is generated for each individual as part of the patient plan and reviewed/modified by a physician as necessary. In the embodiment shown in FIG. 7D, each task includes a task category 166, specific tasks 168, target date 170, patient status 172, and provider status 174. For example, under specific tasks 168 is the task “Appointment Surgeon”. The target data for completing the task is Apr. 1, 2009, and the status of the task is indicated by the color of the flags under the tab patient status 172 and provider status 174. The patient is only able to change the status associated with patient status. Provider status 174 must be changed by the provider when satisfied that the task has been completed.

As discussed with respect to FIG. 3B, task list module 94 automates the generation of tasks by applying a set of rules to the information provided by the patient via the questionnaire and modified by the provider during the patient encounter. For example, for male patients over a certain age (e.g., 40 years old), a task required prior to bariatric surgery is a prostrate exam. In addition, the provider may add to or modify the task list at their own discretion.

Task list interface provides a roadmap of actions to be taken by a patient during a process, such as bariatric surgery. In addition, next steps in the process may depend on the successful completion of each task on the task list. For example, one of the tasks in this process is to lose twenty pounds prior to surgery. If the patient fails to satisfy this task, the surgery may be postponed or canceled.

FIG. 7E is a screenshot 176 of the interface employed by the patient via patient portal 96 to complete a task. FIG. 7F is a screenshot 178 of the interface employed by the provider via provider portal 98 to complete a task. With respect to both interfaces, the patient/provider is able to indicate the date the task was completed and any comments associated with the task. The status of each task list and any comments associated with completed task is stored by LMOCR 10.

FIG. 7G is a screenshot of an inquiry interface 180 employed by the patient to submit questions, concerns, etc. to the provider. For example, in the embodiment shown in FIG. 7G, the patient states that he is having difficulty with the task requirement to lose 5 pounds (lbs.) before the surgery. FIG. 7H is a screenshot of a response interface 182 employed by the provider to respond to inquiries from patients. Correspondence between patients and providers is stored by LMOCR 10.

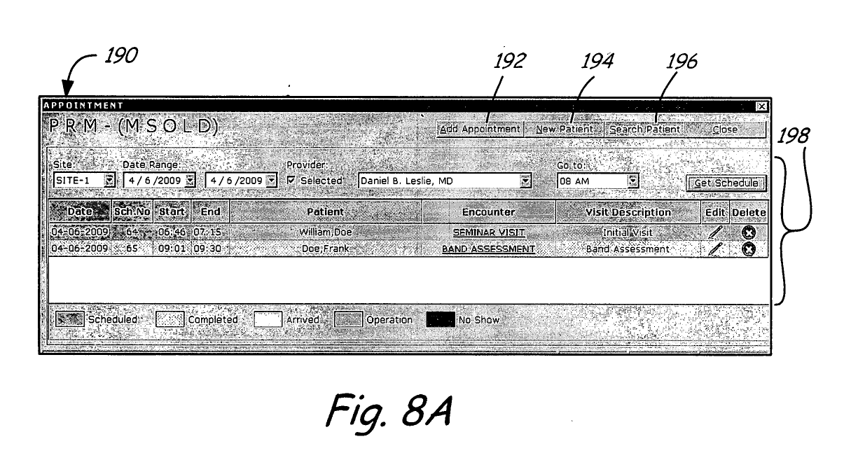

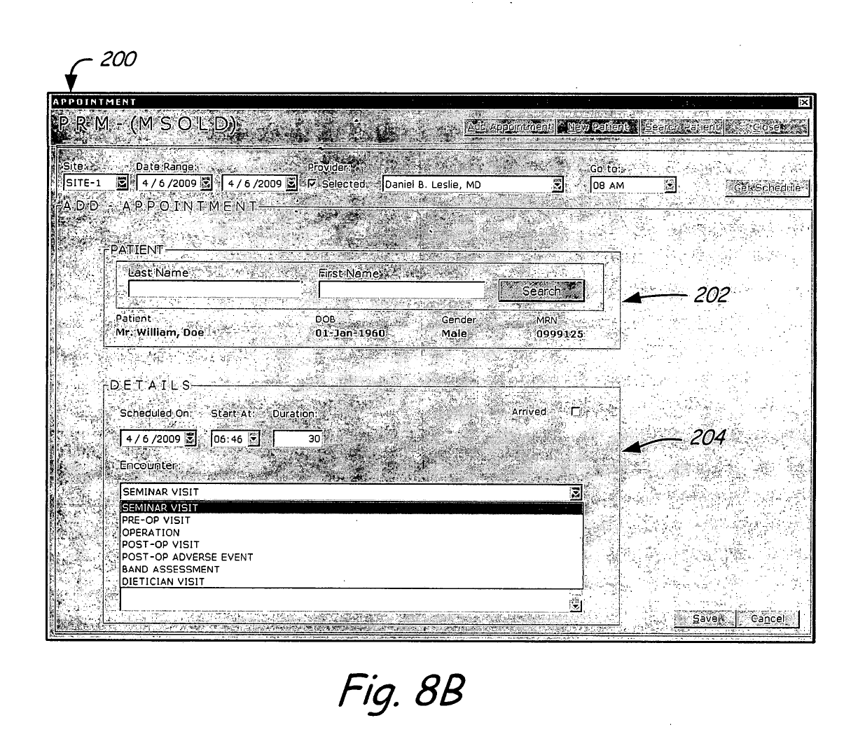

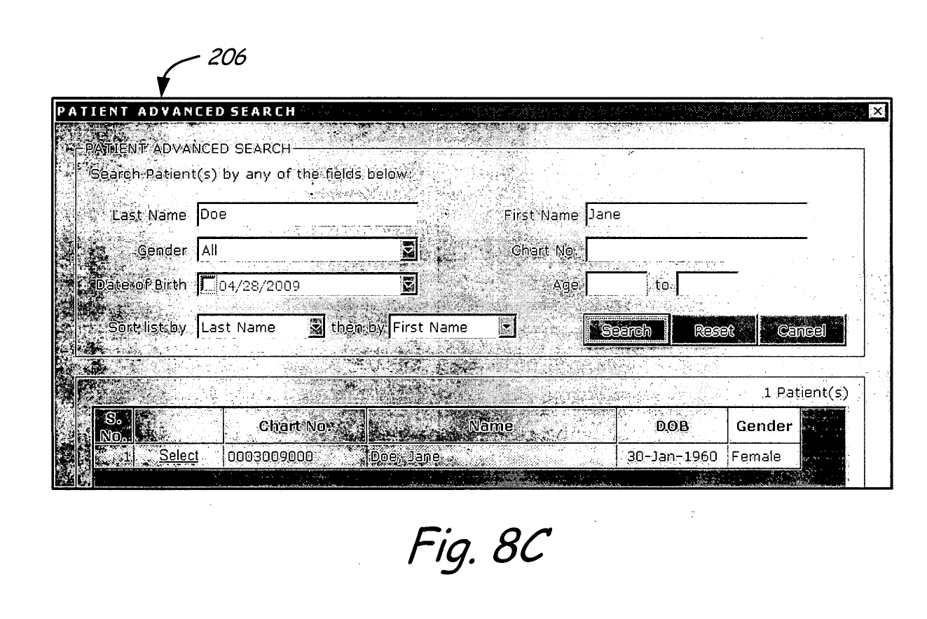

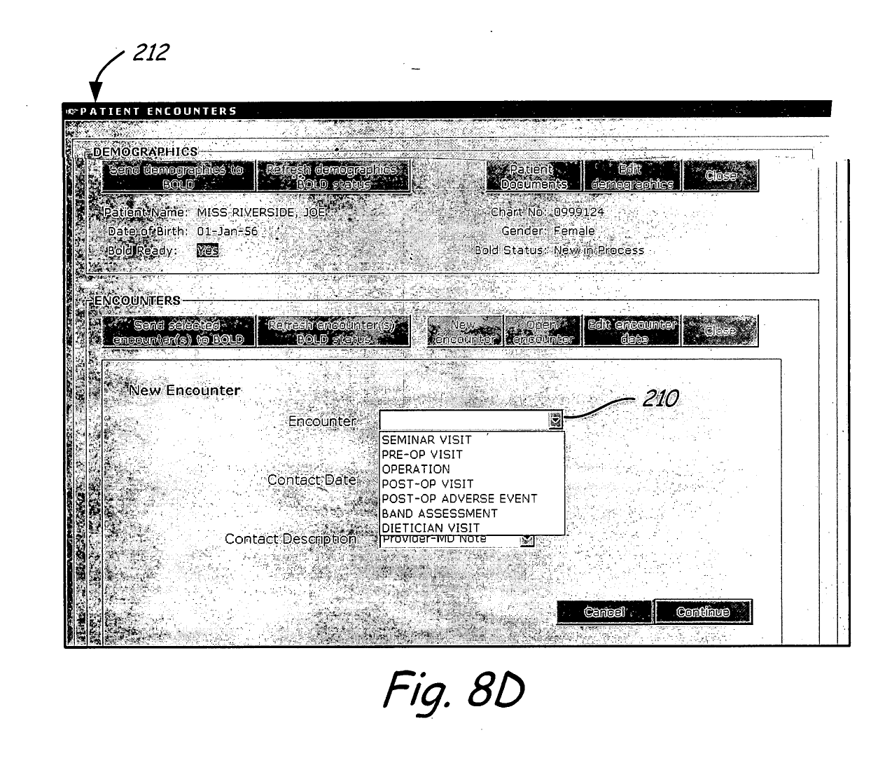

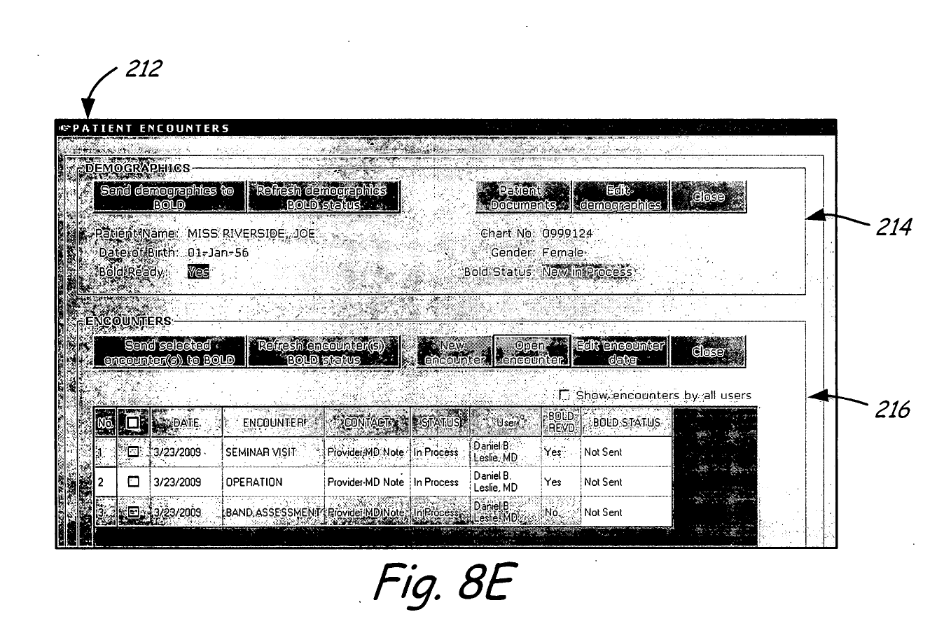

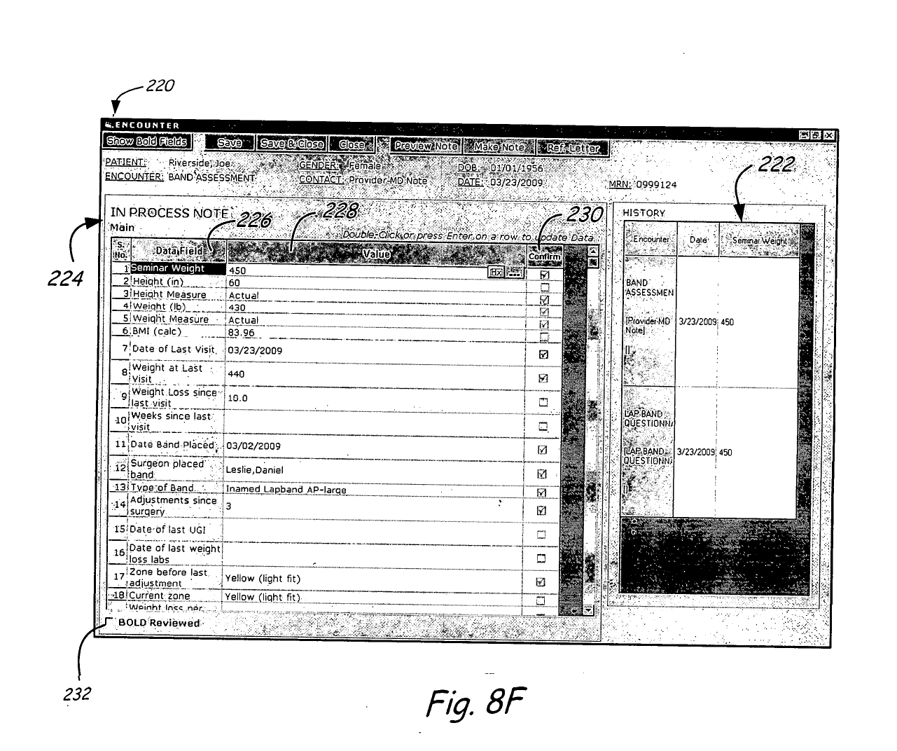

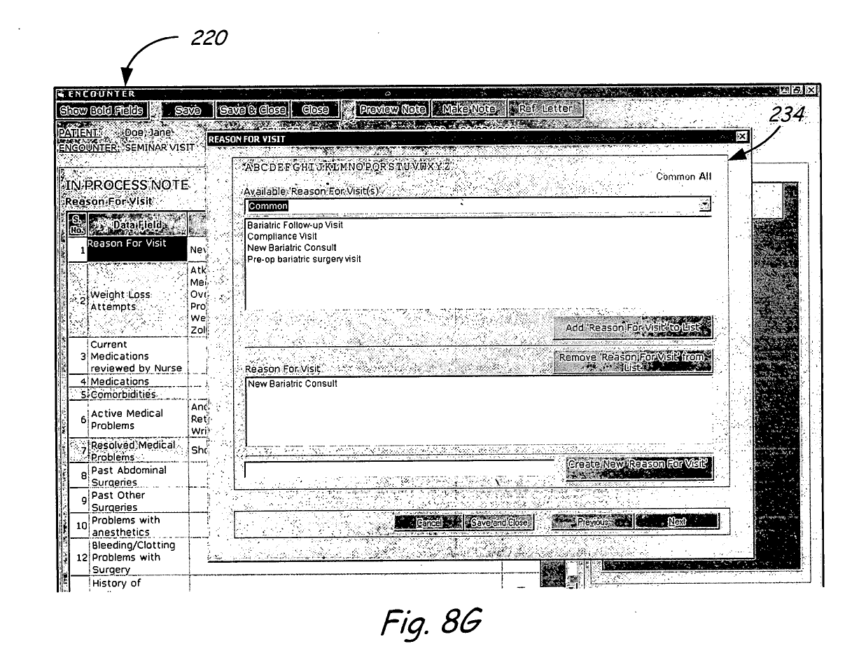

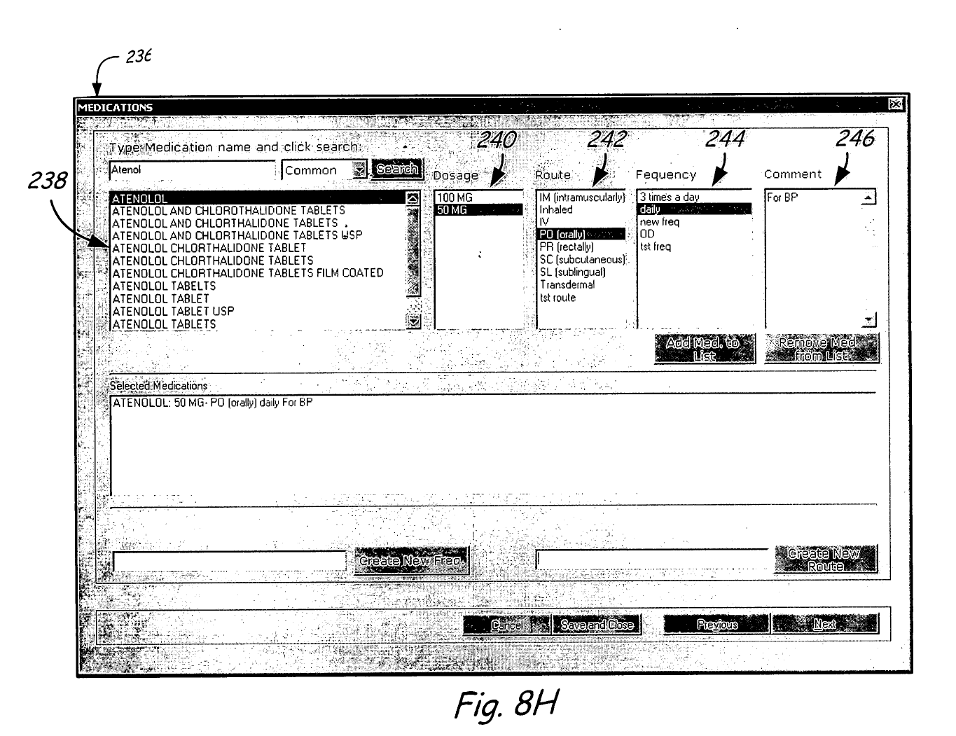

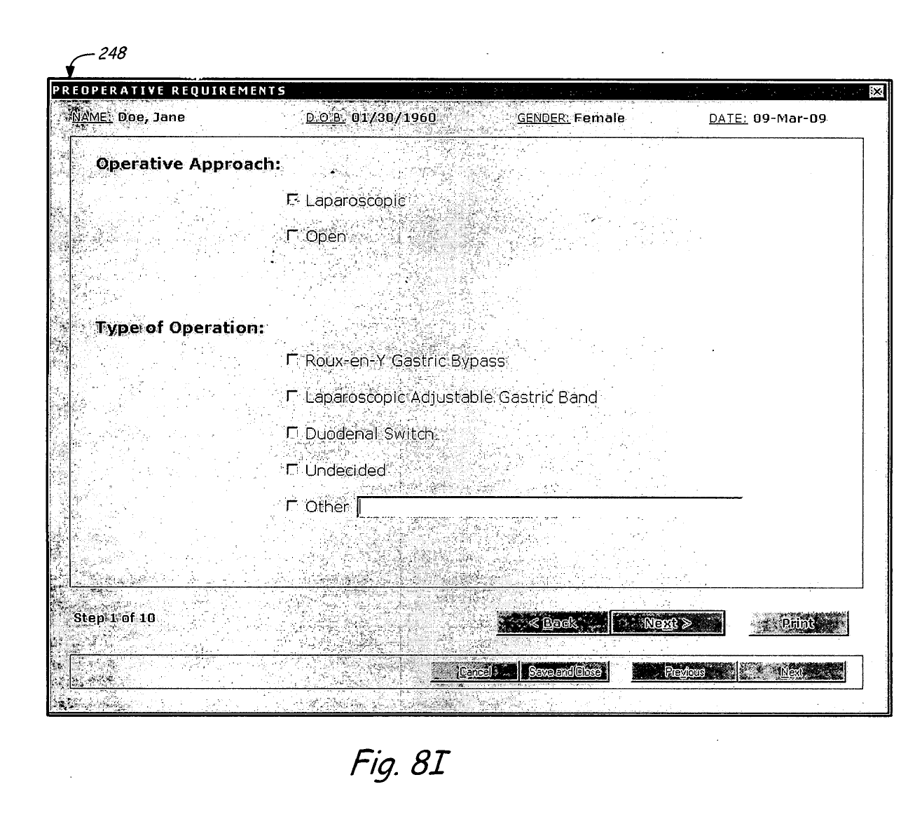

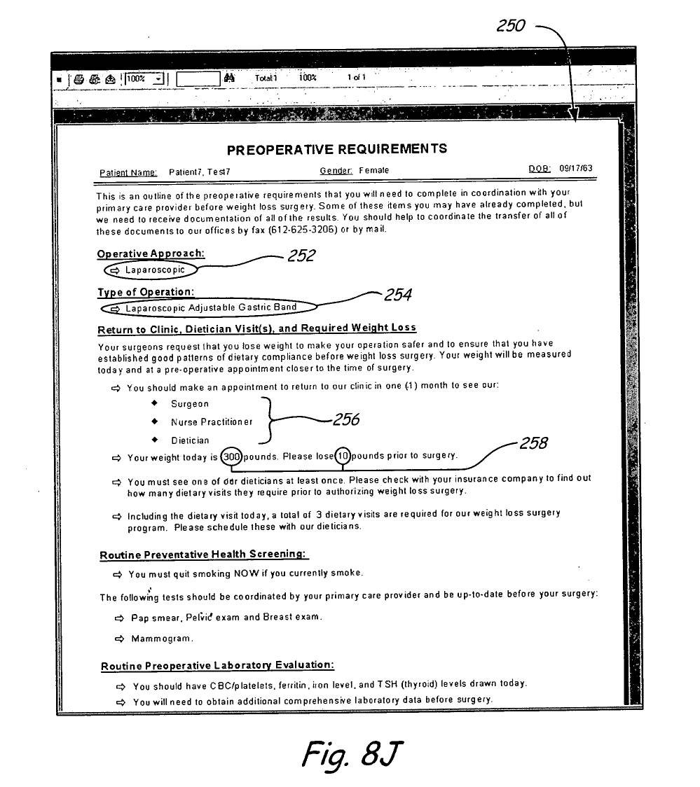

FIGS. 8A-8J are screenshots of the interface employed by a provider via provider portal 98 (shown in FIG. 3B) for scheduling, data collection, task list review, report generation/modification, and communication with a patient by a provider.

FIG. 8A is a screenshot of appointment interface 190 employed by a provider to view/manage appointments. Interface 190 has links/buttons on the top of the interface that allow the provider to add appointments (192), add new patients (194), or search for a particular patient (196). Portion 198, of appointment interface 190, also allows a provider to view all scheduled, completed, arrived, operation (surgical), and no-show appointments for a given day or range of days. The provider enters the range of dates to search and selects the provider, and a list of all appointments is provided. In the embodiment shown in FIG. 8A, the appointments are color-coded based on their status as either scheduled, completed, arrived, operation, or no-show. Information can be modified/edited as desired and stored to LMOCR 10.

FIG. 8B is a screenshot of an appointment search interface 200 that allows a provider to search for appointments based on a particular patient. Patient search portion 202 receives input from a provider regarding a patient's first and/or last name. Details portion 204 allows the provider to edit details regarding a patient encounter. For instance, the provider uses details interface 204 to add an encounter or visit to the schedule. The provider may also note whether the patient has arrived for the scheduled visit.

FIG. 8C is a screenshot of an advanced search interface 207 that allows a provider to search for patients based on criteria other than name. For instance, the provider may employ gender drop-down list 206 to search for patients based on gender, or age range box 207 to search for patients by age. In other embodiments, other criteria relevant to the disease being treated, may be employed to allow a provider to selectively search and locate patients.

FIGS. 8D and 8E are a screenshots of patient encounter interface 208 that allow a provider to manage encounters with patients. In particular, for bariatric surgery (as well as other types of disease management) patient information and physician notes must be reported to a review/credentialing board for authorization and monitoring. This is particularly true for process-drive, longitudinal studies in which the long-term impact of a given treatment on a patient is important.

FIG. 8D is a screenshot that shows the selection of a given encounter with a patient using drop-down list 210 to select a particular encounter for a patient. FIG. 8E shows reporting options available to a provider. In particular, demographic interface 214 allows a provider to send, edit, and review demographic data for a patient and encounter interface 216 allows a provider to send, open, create, and edit encounter data for a given patient.

Demographic data refers broadly all non-personal information collected with respect to a given patient (i.e., not patient name). For bariatric surgery, demographic data may include patient age, sex, weight, race, etc. Demographic data is collected and monitored by review/credentialing boards to monitor the efficacy of treatment. LMOCR 10 collects the required information and formats it for communication at the physician's discretion, to the review board (labeled BOLD). Demographic interface 214 also allows the provider to edit demographic data, view patient documents, and refresh or resend demographic data to the review board.

Encounter reporting interface 216 allows the provider to manage patient encounters (i.e., visits). A provider can create new encounters, open encounters, edit encounter information, and send selected encounter information to a review board (e.g., BOLD). Encounters reporting interface 216 also allows a provider to view which encounters have been sent to the review board and which encounters are ready to be sent to a review board.

FIG. 8F is a screenshot encounter template 220 employed to collect data during an encounter. In the embodiment shown in FIG. 8F, in process note interface 224 includes a plurality of data fields 226 and corresponding value fields 228 for the provider to populate. To reduce the time spent by a provider in populating the value fields 228, information from a previous encounter, information provided by a patient on a patient questionnaire, and/or information collected by a nurse/assistant are automatically used to populate these fields. The physician need only review the information and modify it as required. For example, data fields 226 includes fields such as height, and date band placed. These values will not change from visit to visit. However, for bariatric surgery, fields such as weight may fluctuate significantly from visit to visit. Thus, the provider will need to verify/modify the weight data field at each encounter. Check boxes 230 allow a provider to indicate these data fields that have been confirmed in the current encounter. Unchecked boxes indicate data fields populated from other users and not confirmed by the physician. Other fields, such as body mass index (BMI) are calculated automatically based on height and weight information and cannot be modified manually. Thus, the provider does not need to manually calculate the BMI value, only ensure that the weight data field has been verified/modified.

Having completed the in-process note for a particular encounter, the provider can indicate using BOLD reviewed checkbox, 232 that the encounter note is ready for reporting to the review board.

History interface 222 allows the provider to review previously entered data with respect to a selected field. For example, in the embodiment shown in FIG. 4F the patient's weight is selected such that the patient's weight at each previous encounter is displayed in history interface 222.

FIG. 8G is a screenshot of encounter interface 220, including an example of how data in the encounter template is modified by the physician. In this example, a physician clicks or activates the data field, “Reason for visit.” In response, pop-up window 234 is opened and allows the physician to select from several standard reasons or create a new reason for the visit. The information is then saved to the encounter template.

FIG. 8H is a screenshot of medications interface 236 activated by clicking on the “Medications” data field on the encounter template last shown in FIG. 8F. Medications interface 236 is used to collect a list of medications being taken by the patient. In the embodiment shown in FIG. 8H, selection of a particular medication from list 238 results in the automatic population of the fields associated with dosage 240, route 242, and frequency 244. For example, selection of the medication Atenolol results in the dosage field 240 being populated with likely dosages 100 milligrams (mg) and 50 mg. Likewise, route field 242 is populated with likely methods of ingesting or taking the medication and frequency field 244 is populated with likely frequencies associated with the medication. Having input a selected medication on a particular encounter, the medication will be populated on subsequent encounters unless modified by the provider.

Additional information collected during an encounter, such as allergies, active medical problems, past surgery history, etc., are reviewed and modified in similar fashion. When available, data collected in a patient questionnaire, collected by a nurse, collected in a previous encounter, and/or supplied by a hospital information system (HIS) is used to automatically populate data fields.

FIG. 8I is a screenshot of pre-operative interface 248 used by the physician to identify the type of surgery to be performed, and patient requirements/tasks to be completed prior to the selected type of surgery. Data collected from the physician using the pre-operative interface is completed to generate patient plans/task lists to be completed prior to surgery. In the embodiment shown in FIG. 8I, the physician selects between different operative approaches, including laparoscopic and open, and the type of operation to be performed. Other data provided by the provider via pre-operative interface 248 may include return to clinic requirements, dietician visit requirements, required weight loss prior to surgery, routine preventative health screening requirements, routine pre-operation laboratory evaluation and primary care evaluation, consultations and system evaluations, medical weight loss evaluation, and/or exercise evaluation. Consultations and system evaluations may include psychological evaluations, letter from primary care provider, cardiovascular evaluation, gastrointestinal evaluation, metabolic evaluation, hematology evaluation, and respiratory evaluation.

In addition, the LMOCR 10 includes automated rules that select preoperative requirements based on previously collected information. For example, patients over 50 years old will automatically be required to receive a colonoscopy, patients that indicated on the questionnaire that they had taken fen-phen for more than three months will be required to receive a cardiac echocardiogram, etc. In this way, the collected information is employed to automate the creation of a patient plan and pre-operation tasks list. However, the physician is able to modify the rules when deemed necessary.

FIG. 8J is a screen shot of pre-operative requirements note 250 automatically generated by LMOCR 10 in response to the input provided by the physician using pre-operative interface 248174 (shown in FIG. 8I). For example, in response to the physician selecting an operative approach of laparoscopic and type of operation, the operative approach field 252 and type of operation field 254 are automatically populated to reflect these decisions. Future appointments field 256 is populated with the medical personnel to see in a given time period. Required weight loss field 258 is populated with the weight of the patient as of the encounter date, and the weight loss required prior to surgery. Additional fields are populated based on information previously collected from the patient or provided by the physician using the pre-operative interface. Pre-operative note 250 is given to the patient. In addition, based on input provided using pre-operative interface 248, task lists are automatically generated reflecting the requirement presented in the pre-operation report 248. Task lists are stored by LMOCR 10 and viewable by the patient via patient portal 92 (shown in FIG. 3B).

In this way, the present invention does not require the physician or physician assistant to repetitiously enter pre-operative requirements from physician notes/dictation. Rather, the requirements are automatically populated based on data already collected from questionnaires, encounters, and physician decisions. Although generated automatically, the report is generated to be readable and easily understood by the patient with the look and feel of a dictated letter.

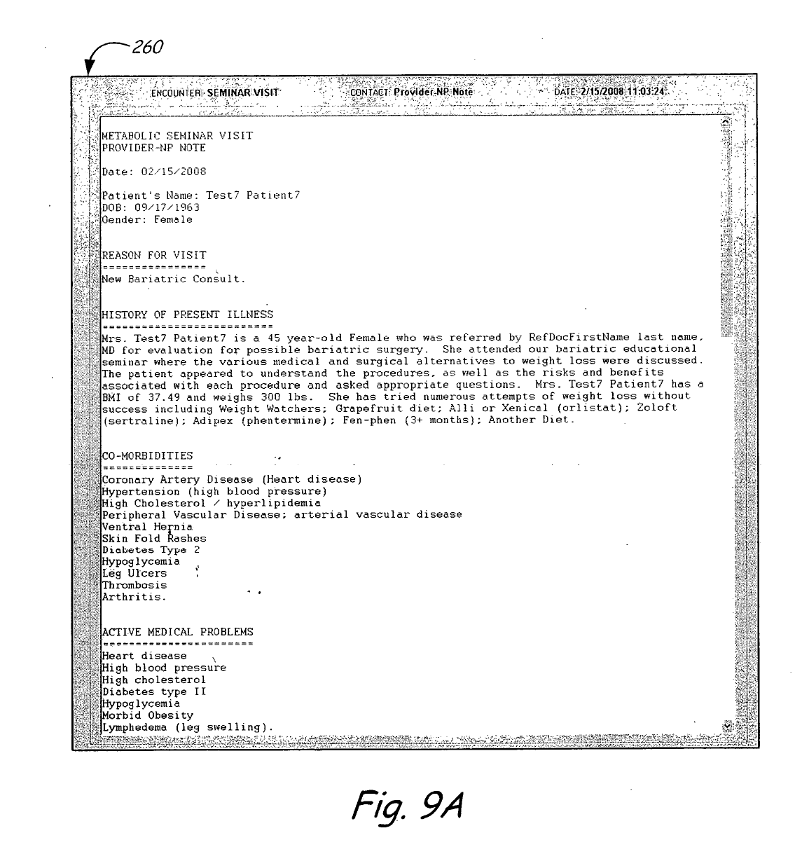

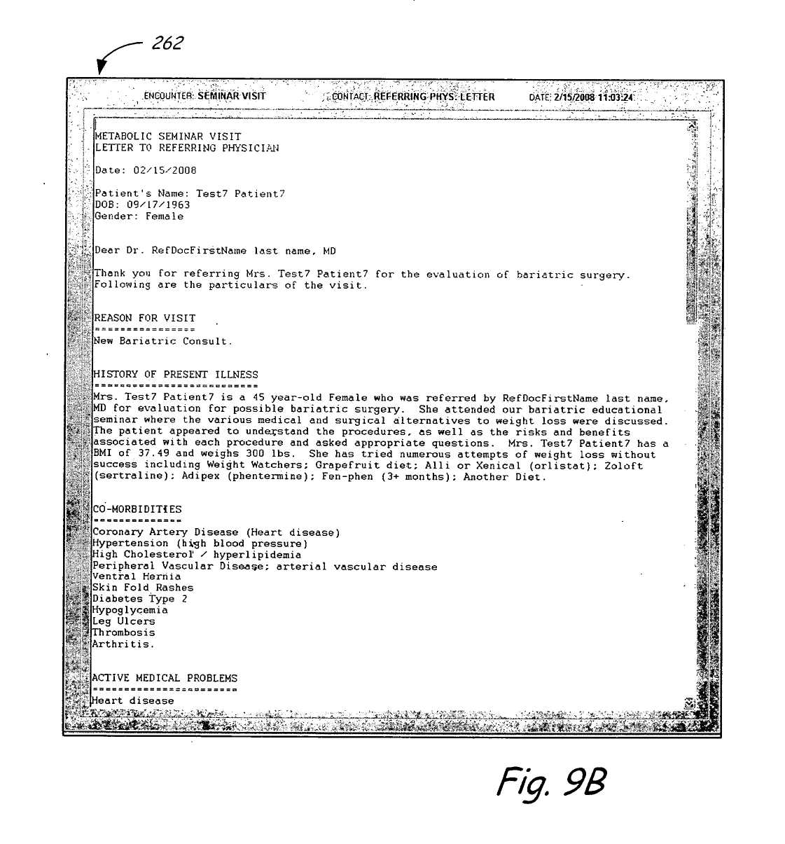

FIG. 9A is a screenshot of automated provider note 260 generated by note module 93 (shown in FIG. 3B) of LMOCR 10 in response to a patient encounter. The letter is automatically generated based on data collected from the patient questionnaire, nurse visit, encounter template, and/or medical records stored by a hospital information system. In one embodiment, provider note 260 is used as a record for billing purposes. For example, in embodiments in which LMOCR 10 is integrated with a hospital information system (e.g., HIS 12 shown in FIG. 1), provider note 260 may be communicated to HIS 12 to initiate a billing event. In embodiments in which LMOCR 10 is stand-alone system that handles patient billing, then provider note 260 may still serve as a billing event, wherein the note is communicated to a medical insurer and/or patient as evidence of services provided along with a bill.

Generation of provider note 260 is automated to reduce provider time in generating the note. However, the provider is able to review and modify provider note 260 prior to the note being communicated to HIS 12, medical insurer, and/or patient.

FIG. 9B is a screenshot of automated referral letter note 262 generated by note module 93 (shown in FIG. 3B) of LMOCR 10 in response to a patient encounter. Referral letters are provided to referring doctors to inform them of the result of an encounter such that the referring doctor (typically, a family physician) is aware of the patient's procedure. Once again, the letter is automatically generated based on data collected form the patient questionnaire, nurse visit, encounter template, and/or medical records stored by a hospital information system. The provider is once again able to review and modify referral letter 262 prior to the letter being communicated to the referring physician.

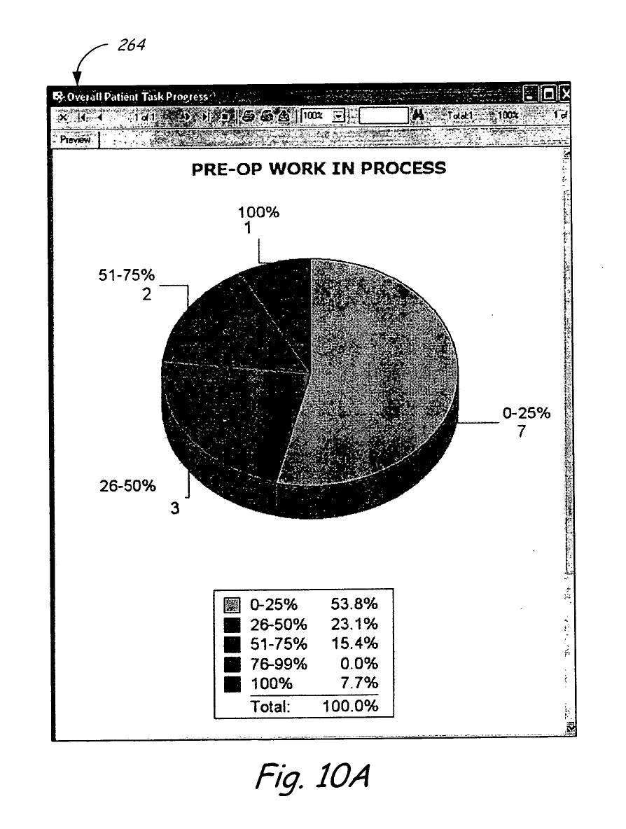

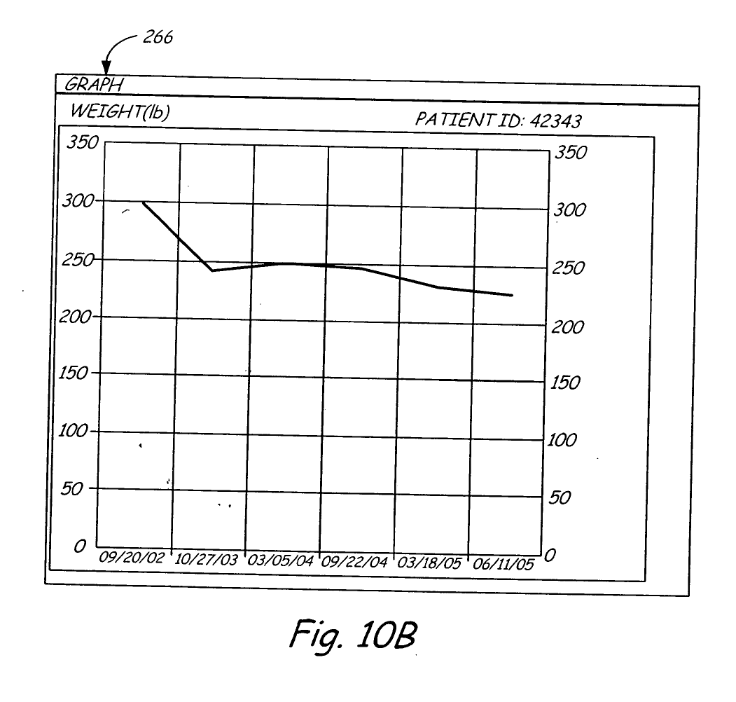

FIG. 10A is a screenshot of a pre-operative patient tracking report 264 generated by note/report module 93 according to an embodiment of the present invention. As discussed with respect to FIG. 2, data collected by LMOCR 10 can be organized into reports. In the embodiment shown in FIG. 10A, a provider (via provider portal 98) interacts with note/report module 93 to search for a number of patients in the pre-operative bariatric process and the overall progress of the patients in completing assigned tasks. In this example, one patient has completed all assigned tasks, two patients have completed 51-75% of assigned tasks, three patients have completed 26-50% of assigned tasks, and seven patients have completed 0-25% of assigned tasks. This type of report allows a physician to gauge the overall progress of patients and make determinations regarding whether additional patients can be introduced into the process pipeline.

FIG. 10B is a screenshot of a report generated with respect to a particular metric for an individual patient by note/report module 93. This type of report is useful in gauging the efficacy of a particular treatment with respect to a relevant data field (e.g., weight). These reports may be generated for use by the physician or may be communicated to credentialing bodies for use in analyzing the efficacy/benefits of a particular procedure. A provider (via provider portal 98) communicates the type of report to be generated to note/report module 93. In response, note/report module 93 retrieves data from patient database 82. This may include data relevant to a particular patient or date collected from a plurality of patients.

In the example provided in FIG. 10B, the report is generated with respect to a single patient, and provides in graph form weight loss by the patient over time. This report is useful both to the provider and credentialing boards to quickly view and assess the results of a particular procedure, in this case, bariatric surgery.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A longitudinal medical outcome collection and reporting (LMOCR) system comprising:
a patient database for storing medical records and information pertaining to a plurality of patients; and
an application server having a number of applications for communicating with the patient database, a remotely located patient device, and a remotely located provider device, wherein the application server includes:
a patient module that displays on the patient device a patient portal that allows the patient to interact with the LMOCR system, the patient module providing a questionnaire to the patient portal to collect information from a patient, wherein the patient questionnaire applies a first set of rules to collected patient information to selectively modify the questionnaire to collect relevant follow-up information from the patient, wherein all patient information collected by the patient module is stored in the patient database; and
a provider module that displays on the provider device a provider portal that allows a provider to interact with the LMOCR system, wherein the provider module applies a second set of rules to collected patient information to translate the collected patient information into a format relevant to the provider, wherein the provider is able to review, modify, and add to the collection of patient data stored in the patient database.

2. The LMOCR system of claim 1, wherein the application server further includes:
a note-creation module available to the provider via the provider portal to automate the generation of provider notes based on input provided by the provider regarding the type of note to be generated and information stored in the patient database.

3. The LMOCR system of claim 2, wherein the note-creation module generates reports based on input provided by the provider regarding the type of report to be generated and information stored in the patient database.

4. The LMOCR system of claim 3, wherein the report is generated specific to a particular patient.

5. The LMOCR system of claim 3, wherein the report is generated with respect to data collected from a plurality of patients.

6. The LMOCR system of claim 1, wherein the application server further includes:
a task list module that automates generation of a patient task list based on the collection of patient data stored in the patient database, wherein the provider reviews and modifies the task list via the provider portal and the patient reviews and indicates the completion of each task via the patient portal.

7. The LMOCR system of claim 1, wherein the patient database stores information regarding the data information was collected and the source of the collected information.

8. The LMOCR system of claim 1, wherein translation of collected patient information includes automatically providing to the provider portal comorbidities associated with disease information provided in the collected patient information for the provider to review.

9. A method of collecting and organizing data in a medical information system, the method comprising:
providing a patient intake questionnaire to a patient via a patient portal;
modifying the patient intake questionnaire based on answers provided by the patient to collect relevant patient information;
storing collected patient information to a patient database;
translating the collected patient information into a format relevant to a provider; and
displaying translated patient information to a provider via a provider portal for review/modification of the collected patient information by the provider.

10. The method of claim 8, wherein modifying the patient intake questionnaire includes applying a first set of rules to the answers provided by the patient to generate follow-up questions for display to the patient via the patient portal.

11. The method of claim 8, wherein translating the collected patient information into a format relevant to the provider includes applying a second set of rules to the collected patient information to display relevant information to the provider including comorbidities associated with diseases identified in the collected patient information for the provider to review.

12. The method of claim 8, further including:
generating automated provider notes based on input received from the provider via the provider portal regarding the type of provider note to generate and the collected patient information.

13. The method of claim 9, further including:
generating automated reports based on input received from the provider via the provider portal regarding the type of report to be generated and the collected patient information.

14. The method of claim 13, wherein generating automated reports includes generating a report with respect to a particular patient.

15. The method of claim 13, wherein generating automated reports includes generating a report with respect to a plurality of patients.

16. The method of claim 8, further including:
generating an automated task list based on the collected patient information, the generated task list being reviewable by the provider via the provider portal and accessible by the patient to view and complete via the patient portal.
